(19) United States
(12) Patent Application Publication
(10) Pub. No.: US 2021/0256622 A1
(43) Pub. Date: Aug. 19, 2021

(54) METHOD AND COLLABORATIVE PLATFORM FOR INTELLIGENT PURCHASE DECISIONS

(71) Applicant: ZILLION INSURANCE SERVICES, INC., PALO ALTO, CA (US)

(72) Inventors: JOHN KEVIN HARTLEY, LOS ALTOS, CA (US); CRAIG BENTLEY LYONS, CHATTANOOGA, TN (US); WILLIAM ADAM BLACK, HANOVER, NH (US)

(73) Assignee: ZILLION INSURANCE SERVICES, INC., PALO ALTO, CA (US)

(21) Appl. No.: 17/269,998

(22) PCT Filed: Sep. 16, 2019
(86) PCT No.: PCT/US2019/051362

§ 371 Date: Feb. 19, 2021

Related U.S. Application Data
(60) Provisional application No. 62/731,899, filed on Sep. 15, 2018.

(51) Int. Cl. G06Q 40/08; G06Q 20/20; G06Q 20/02; G06Q 20/38; G06Q 10/10; G06F 16/23; G06F 8/61

(52) U.S. Cl. CPC G06Q 40/08; G06Q 20/201; G06Q 20/202; G06Q 20/02; G06F 3/04842; G06Q 10/10; G06F 16/2315; G06F 8/61; G06Q 2220/00; G06Q 20/389

(57) ABSTRACT

In one embodiment, a collaborative platform to inform and facilitate an intelligent purchase decision is provided. The platform includes a point of sale device having a processor with a processor implementable widget for receiving customer data, the widget being configured to transmit the customer data to a host server remote from the point of sale device. The host server includes a processor implementable rating engine, the rating engine being configured to provide the customer specific information to a third party evaluator, perform a customer evaluation assessment based on third party customer information received from the third party evaluator, perform an item valuation based on the purchase price information and the item specific information, determine whether the customer is eligible to purchase an additional purchase item based on the customer evaluation assessment and the item valuation, and provide to the point of sale device offer data.

### CROSS REFERENCE TO RELATED APPLICATION

The present application claims the benefit of U.S. Provisional Patent Application, Ser. No. 62/731,899; by Hartley et al., entitled METHOD AND PLATFORM FOR INTELLIGENT INSURANCE DECISIONS, filed Sep. 15, 2018, herein incorporated by reference in its entirety.

### BACKGROUND

Transactions requiring the input of and processing of a large amount of information are often cumbersome. This is especially true if the information needed to complete the transaction is located in different databases, applications, and physical locations.

What is needed is a way to simply the purchaser's and seller's experience during transactions. Further, what is needed is a tool to provide related sale offers to enhance the transaction to allow the parties to have as much information from multiple sources easily displayed so allow informed and intelligent decision regarding any related/beneficial additional purchase.

### SUMMARY

In one embodiment, a collaborative platform to inform and facilitate an intelligent purchase decision is provided. The platform includes a point of sale device having a processor with a processor implementable widget for receiving customer data including (i) customer specific information; (ii) item specific information of an item; and (iii) purchase price information of the item. The widget is configured to transmit the customer data to a host server remote from the point of sale device. The host server includes a processor implementable rating engine, the rating engine being configured to provide the customer specific information to a third party evaluator, perform a customer evaluation assessment based on third party customer information received from the third party evaluator, perform an item valuation based on the purchase price information and the item specific information. The item specific information including comparative sale data, item valuation based on current market price of the item; and valuation history data of the item. The rating engine is further configured to determine whether the customer is eligible to purchase an additional purchase item based on the customer evaluation assessment and the item valuation, and provide to the point of sale device one of either: (i) offer data related to the additional purchase item if the customer is eligible to purchase the additional purchase item, or (ii) rejection data if the customer is not eligible to purchase the additional purchase item. The point of sale device being configured to display the offer data and a selectable field on the point of sale device to a customer so as to allow the customer to complete the additional purchase.

In one specific implementation, a method is provided for insuring an item at a point of purchase. The method comprises installing a plug-in processor implementable application into a merchant's point of sale device, the processor implementable application providing a display comprising and activation field on the merchant's point of sale device, providing from the merchant's point of sale device item purchase information including customer specific information, item specific information, and purchase price information upon selection of the activation field, to a rating engine at a remote host site, providing from the rating engine at least some of the customer specific information to a third party risk evaluator, performing at the rating engine a customer risk valuation assessment based on customer specific risk information obtained from the third party risk evaluator; performing at the rating engine an item valuation based on the purchase price and the item specific information. In this implementation the item specific information may include comparative sale data, item component valuation data based on current market price, and valuation history data related to the item from a third party blockchain distributed ledger. This implementation may further include performing at the rating engine an insurance premium calculation to generate an insurance quote based on the customer risk valuation assessment and the item valuation, providing to the merchant's point of sale device the insurance quote for display on the point of sale device, and displaying at least one selection field on the point of sale device to a customer corresponding to the customer specific data so as to allow binding of insurance at the quoted premium from the point of sale device upon selection of the at least one selection field.

In yet another implementation, a method for insuring an item at a point of purchase is provided including installing a plug-in application on a retailer's e-commerce checkout system, the plug-in application providing a display comprising and activation field on the user's point of purchase device and providing item purchase information including customer specific information, item specific information, and purchase price information upon selection of the activation field, to a remote site rating engine. This implementation may further include providing from the rating engine at least some the customer specific information to a third party risk evaluator, performing at the rating engine a customer risk valuation assessment based on customer specific risk information obtained from the third party risk evaluator, and performing at the rating engine an item valuation based on the purchase price and the item specific information, which may include comparative sale data and item component valuation data based on current market price. This implementation may further include performing at the rating engine an insurance premium calculation to generate an insurance quote based on the customer risk valuation assessment and the item valuation, providing to the user's point of purchase device the insurance quote for display on the user's point of purchase device, and displaying at least one selection field on the point of purchase device to a customer corresponding to the customer specific data so as to allow binding of an insurance contract at the quoted premium from the point of purchase device upon selection of the at least one selection field.

### BRIEF DESCRIPTION OF THE DRAWINGS

FIG. 1 illustrates a functional block diagram of a platform to provide a collaborative system that collects, retrieves, and integrates disparate data to inform, make and execute more intelligent decisions with regard to a product offer and its sale.

FIG. 2 illustrates how the platform interacts and with customers internal systems, and third-party systems.

FIG. 3 illustrates a process interaction flow with the platform.

FIG. 4 shows an example process flow of an item/product revaluation.

FIG. 5 illustrates a potential format for display of platform generated information on a graphical user interface.

### DESCRIPTION

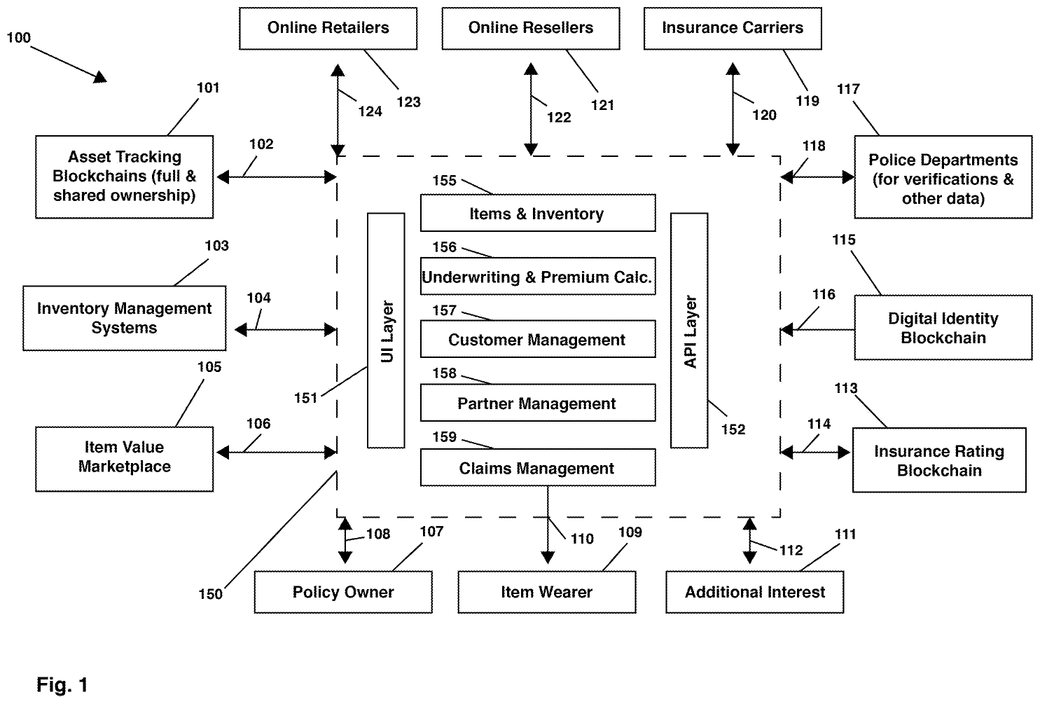

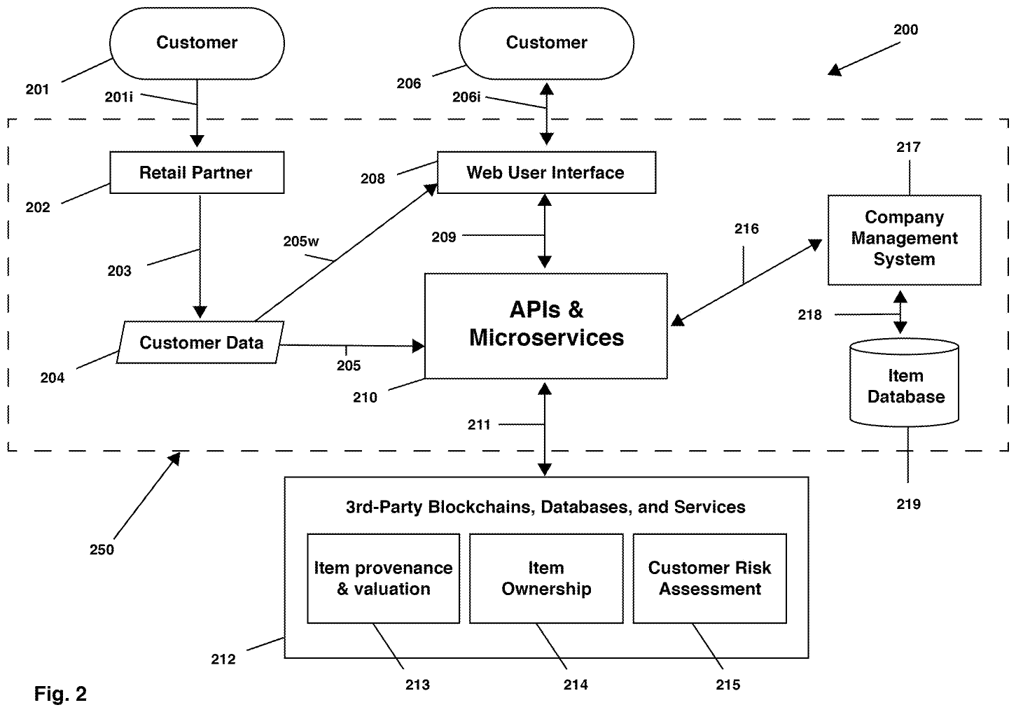

FIG. 1 illustrates a platform 100 to provide a collaborative system that collects, retrieves, and integrates disparate data to inform, make and execute more intelligent decisions with regard to a product offer and its sale. This embodiment may include, a processor implementable plugin/widget application which is installed on a point of purchase device at a retail partner 202 (FIG. 2), e.g. in the e-commerce checkout systems of online retailers, or to a merchant's system for a point of sale device, to enable bidirectional real-time communication of data between the retailer (and/or customer) and a host platform 150.

As shown in FIG. 1, the host platform 150 may communicate 124, 122, 120, with online retailers 123, online resellers 121, and insurance carriers 119. Also, the host platform may communicate 108, 110, 112, with the policy owner 107, the item owner or person in possession of the item such as the item wearer 109, and any additional party 111 that might have interest in the item. In addition, the host platform 150 may communicate 118, 116, 114, with police departments 117, digital identity blockchain 115, and an insurance rating block chain 113 (which is analogous to a credit report, but for insurance). Moreover, the host platform 150 may communicate 102, 104, 106, with asset tracking blockchains 101, inventory management systems 103, and item value marketplace 105. The user interface layer or UI layer 151 as well as the application interface layer or API layer 152 facilitate in these communications. The UI layer handles the initial communications

FIG. 2 illustrates how the platform 250 interacts 201i and 206i with customers 201 or 206, interacts 203, 205, 209, 216, and 218 with internal systems 210, 217, and 219, and interacts 211 third-party systems 212. A customer profile is established in the platform 250 when a customer 201 makes or initiates a purchase of a product offered by a retailer partner 202, or by a customer 206 through a web user interface 208. The initial information 201i about the customer 201 is input by the retail partner 202. The initial customer data 204 supplied 203 by the retail partner 202 can include the initial information 201i provided by the customer 201 (can include any prior customer information retained by retail partner 202), along with additional information provided by the retail partner 202, i.e. the details of the item purchase, for example purchase price, details about the item such as the physical characteristics, style, condition, or quality of the item, the market value of the item, and the selling or purchase price. The customer data 204 is transferred 205 by the retail partner 202 to be processed by a platform 250 server 210, which contains the application programming interfaces or APIs and microservices for the purpose of assessing whether to offer an additional product or service to the customer for purchase along with the underlying product or service. The server 210 may be a single processor based computer, or in some embodiments, it may be a distributed computer/computing system.

In the case of the purchase of a jewelry product, the platform 250 can assess insurance eligibility, risk, premium pricing, item provenance, item ownership, and more. Said data processing is handled by a series of internal services 155-159 (FIG. 1), such as items and inventory 155, product valuations and price 156, (which could be underwriting and premium calculations, in the example case of insurance products), retail partner management 158, and claims management 159, and 3rd-party services 212, such as blockchains, databases, or services that provide item provenance and valuation 213, item ownership 214, and customer risk assessments 215. When a request for additional product or service, such as a policy purchase request has been validated and processed, data including (but not limited to) customer details, order details, and granular item details is stored in various databases 217, 219. The company management system 217 stores product management information, for example renewals, billing and payment information, and claims, while the item database 219 stores specific product information.

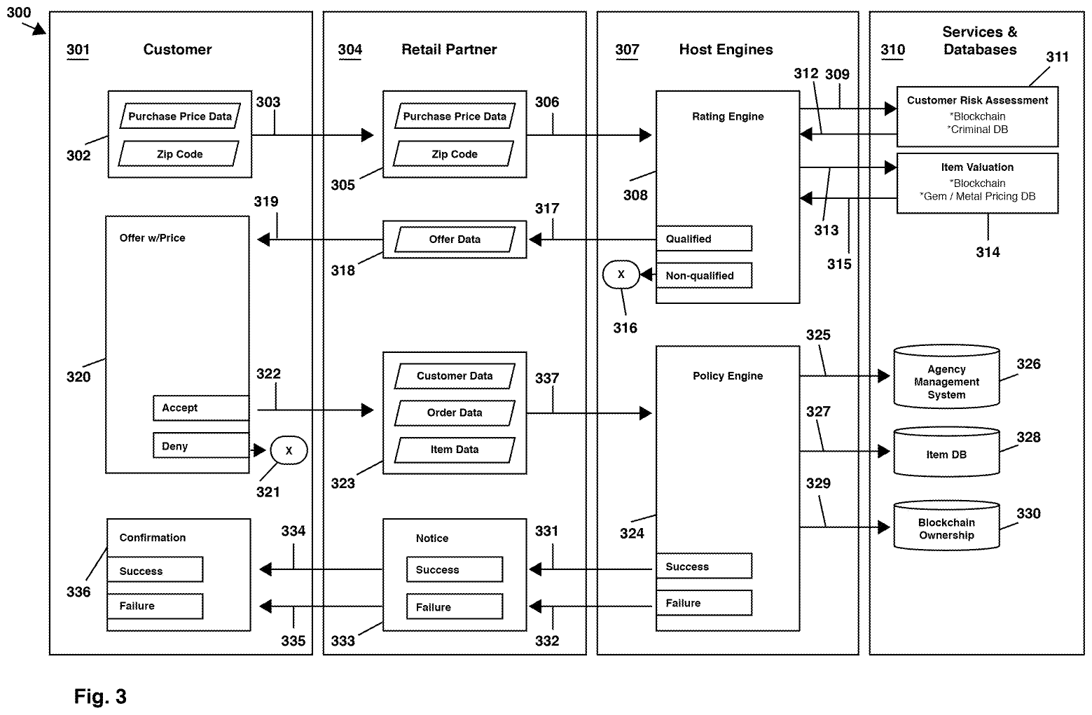

Referring to FIG. 2, further customer information 201i, such as customer acceptance/rejection of a secondary offering as part of the initial purchase, or after an initial purchase, is also an input by the customer 301 (FIG. 3) to the retail partner upon approval/rejection of the secondary product offering 320.

FIG. 3 illustrates a process interaction flow 300 with the platform 250 (FIG. 2). With this platform 250 (FIG. 2), at the checkout 303, either prior to or after checkout, with the consent of the customer 301, the retailer partner platform 304 sends 306 to the host platform 307, data 305 regarding the customer, the order, and the items/services being purchased. The host platform 307 uses this data to determine whether a customer is eligible or qualified, or non-qualified for an additional purchase, with a built in rating engine 308. If the customer is qualified, offer data 318 is provided 319 to the customer in the form of an offer with price 320, so that the customer 301 may accept or decline 321 the offer/price 320. If the customer accepts the offer 322, the retail partner 304 provides 337 the customer data, the order data to the host engine 307. The transaction engine 307 then completes the transaction. In the case of an insurance policy, the transaction engine 324 is a policy engine that creates an insurance policy. The transaction engine stores the relevant information in the company management system 326, the item database 328, and in the blockchain ownership database 330, and reports 331 or 332 the success or failure of the transaction to platform 250 (FIG. 2) on the retail partner 304. The remote portion of the platform 250 at the retail partner receives notice 333 of the success 334 or failure 335 of the transaction, such as for example notice whether to grant or deny the insurance policy request. The confirmation 336 of the success or failure of the transaction, such as for example the confirmation of the policy issuance, is displayed to the customer 301 at the point of sale.

For example, in the case of jewelry, the host platform 307 uses this data to determine whether or not the customer is eligible for an insurance policy with a built-in rating engine 308, such as an underwriting engine. The rating engine is a system that resides on the host platform 307 that determines eligibility and price for a requested product or service. In some embodiments, the rating engine may be an underwriting engine residing in the host to determine eligibility and premium price for a requested policy. In this specific example, it incorporates information from various sources. i.e. services and databases 310, to make decisions, including (but not limited to) the insurance carrier company, item provenance databases and blockchains, customer risk assessment 311 such as customer fraud databases and blockchains, and item valuation services 314.

By frequently querying for changes in material valuation such as prices of precious metals or gems, the platform is able to provide unique advantages. Customers and insurance carrier partners benefit by having up-to-date coverage on their items so customer are not paying too much, and items are neither under-insured nor over-insured. If the customer is eligible, host platform underwriting engine leverages a multitude of internal & external services, such as for example, customer risk assessment 311, which may utilize criminal database assessment, relevant customer specific insurance history (which may be contained/stored in a block chain) and customer residence or item storage location to calculate the appropriate rate based on the data. Optimally, within milliseconds or less, the online retailer integration provides the customer with the cost of insurance and an option to purchase.

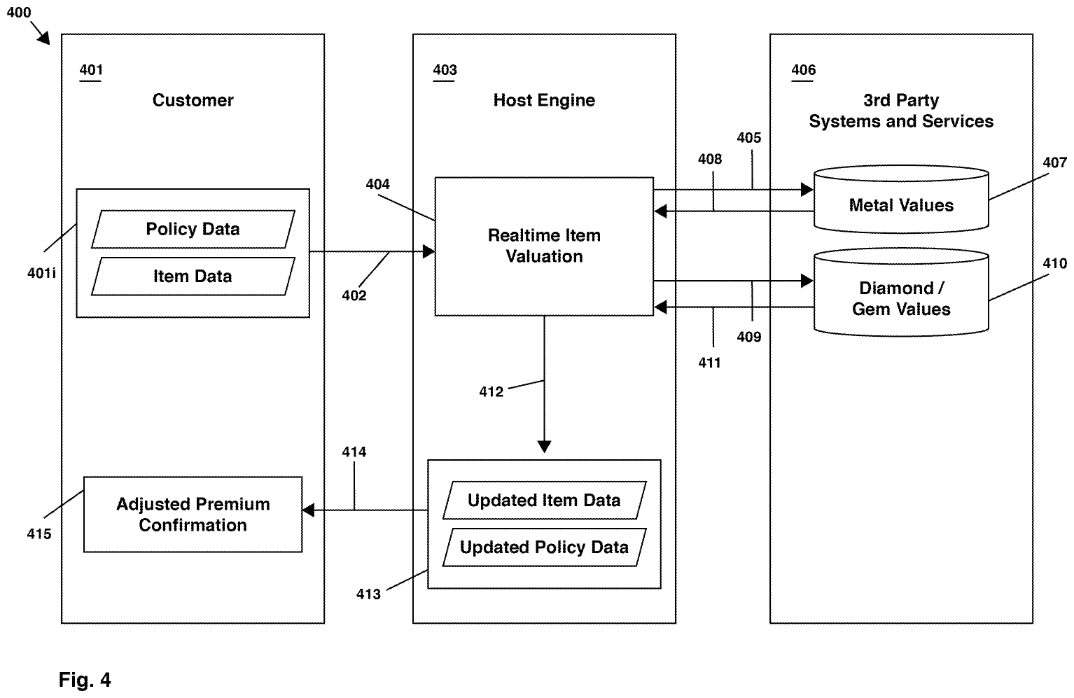

FIG. 4 shows a process flow 400 for a specific example of an item/product revaluation. This may be done proactively, or periodically, such as at a renewal of a policy or a service. The platform host engine 403 will perform a real time item valuation 404 based on customer 401 identifying data 401i, such as for example policy data or item data. The real time item valuation 404 is performed by accessing 405 and 409 third party systems and/or services 406, such as in the case of jewelry, its component values, i.e. current metal values 207 and diamond/gem values 410 information. The real time item valuation with the retrieved 405 and 409 values 407 and 410 are used to update the item data 413, such as for example update the policy data and update the item data to provide 414 adjusted item cost confirmation 415, for example an adjusted premium confirmation.

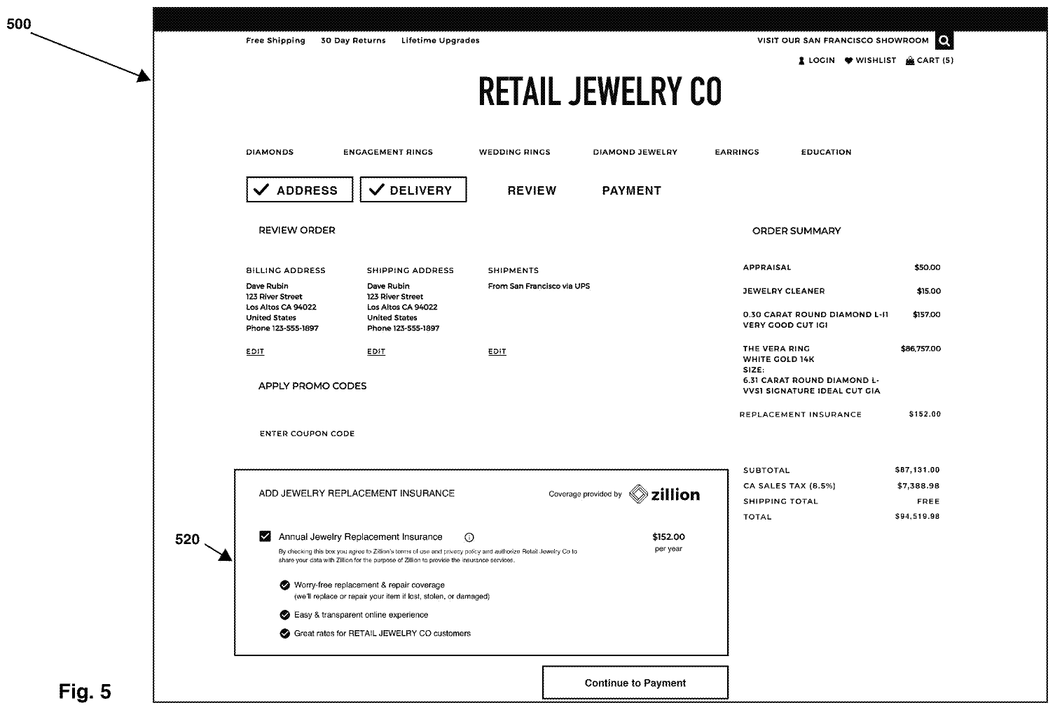

FIG. 5 illustrates a potential format for display of client data information and offer (or rejection) data, and/or if desired any other displayable data discussed herein, on a graphical user interface 500. In a presently preferred embodiment, with one click of a mouse, or touch of a touch screen of a selectable click box or the like in box 520, the customer can continue to payment and purchase the additional item, in this example an insurance policy, i.e. Annual Jewelry Replacement insurance, and the cost of the additional item is added to the cost of the initial item for purchase, preventing the need to make a separate purchases after the initial item has been purchased. An advantage of this is that an accurate, substantiated quote can be provided to the purchaser based on the particular item and market data at the point of sale for the purchaser to include at the time of and with the purchase of the item.

In some implementations, the customer data 204 may be supplied 205w via the web user interface 208 to the platform server 210. In this implementation, the retail partner 202 enters the customer data via the web user interface 208, in the situations where the customer data needs to be amended, the customer data 204 needs to be reformatted, or the retail partner uses the web user interface to enter the customer data 204 directly, for example.

When the insurance is elected by the customer, the online retailer integration sends additional detailed data regarding the customer, order, and items/services being purchased. The platform uses this data to create an Account, Policy, and all necessary legal documents which are automatically filed & sent to the customer.

In some implementations, the platform also stores detailed data about the items and their subcomponents in an internal Item database, providing a unique level of granular information for the customer and insurance carrier. This gives the platform a unique granularity of items that are or are not related to each other. For example, a diamond ring which actually contains a band and a diamond vs. a bracelet that has no subcomponents are stored differently in the Item database. This level of granularity provides customers with more accurate insurance since material value fluctuations can be tracked separately. It can also ease the claims process in examples such as a when a diamond is lost from a band, but the band is not lost. The platform can simply facilitate replacement of the diamond in this example.

In one possible embodiment, the platform allows for dynamic real-time adjustment of insurance and premium based on inventory, values, and market data. With its third-party integrations 405-411 (FIG. 4:), the platform is able to monitor and react to fluctuations in values of valuable assets (i.e. gold, platinum, silver, diamonds, other gems). When inventory fluctuations of a given type are detected by the platform, the platform automatically selects all in-force insurance policies that should be changed as a result of the fluctuations, and re-calculates their premiums accordingly 404-415 (FIG. 4:). Additional platform automation updates or replaces the appropriate virtual objects and documents and invoices or refunds the customer as appropriate.

Optionally, the platform includes an online Internet accessible graphical user interface allowing participants (Customers, Retail Partners, Insurance Carriers) to interface with the platform 208-210 (FIG. 2:). With this interface, customers may be provided with the ability to interact with their insured items and policies to monitor their insurance status, item value, and changes to their policy. Further, in some embodiments the user interface can guide users through many complex insurance functions such as making claims, renewing their policies, and making endorsements, for example. In some possible embodiments, if the person using/wearing the item is different from the customer, he/she also has an Internet user interface account, allowing him or her to interact with the items & policies on a more limited basis.

In some optional embodiments, Retailer, Insurance Carriers, and/or Authorities are provided with applicable information regarding the services, policies, and item/customer specific data. Retail partners may be provided with the ability to view and manage aggregate data about their inventory, customers, trends, and claims that concern them (i.e. repairs or replacements). Additionally, Retail partners may be provided with the ability to manage their financial obligations with Zillion. Also, Insurance Carriers may be provided with the ability to use the Internet user interface to view and manage aggregate data about the policies they carry or have carried, trends, and claims that concern them. In the case of loss or theft, a significant amount of communication occurs with the local Police Department. The platform's User Interface enables Police Departments to participate directly 117-118 (FIG. 1), simplifying the process of reporting incidents and sharing data and forms specific to the loss.

In some embodiments, the platform leverages blockchain technology or distributed ledger information (typically encrypted) to perform digital identity research and management. This blockchain technology may be utilized by a rating engine not only during the initial request and offer for insurance 301-319 (FIG. 3), but also thereafter as part of any premium adjustment along with the value adjustment 401-415 (FIG. 4). Digital Identity data gives the platform a unique opportunity to identify previously-fraudulent prospective customers, thereby reducing risk for the Insurance Carrier and allowing the platform to improve insurance rates. Additionally, participation in Digital Identity blockchains allows the platform to report fraudulent customer behavior, which has the advantage of improving user confidence industry-wide, and leading to improved efficiency, and ultimately reduced insurance premiums.

A further advantage of some embodiments, is that the platform is able to “attach” an insurance policy to an Item or set of Items, thereby enabling the coverage to follow the insured item(s) rather than the person. This may be accomplished with an ownership blockchain upon creation of the policy as illustrated in FIG. 3 at 329-330. Thus, an ownership blockchain is created or updated upon creation of the policy. Enabling coverage to follow the insured item(s) can occur through the platform, with or without blockchain data, however, using of a blockchain creates a more robust and reliable system to provide portable insurance, one that is assignable or re-assignable. By re-assigning coverage to a new owner of item(s), the platform is able to decrease the overhead of multiple policy endorsements/cancellations/creations, providing efficiency and ultimately reduced insurance premiums. This also saves time for the customer, and prevents the risk of a gap in coverage for the item(s).

Another aspect of some embodiments is that the platform allows for shared ownership of one or more assets on one or more policies. Through the use of multi-tenant database architecture at the policy level, the platform is able to dynamically adjust the application of ownership changes to an asset, and dynamically re-calculate the changes in premium & documentation necessary to support the change. The platform is able to track the fractional ownership and changes in those fractions within its internal databases, as well as with blockchains for additional historical data security.

An advantage of the platform databases along with 3rd party blockchains is that they contain data useful to Insurance Carriers to determine customer risk profiles and the status of items they are insuring, or may be considering insuring. This allows Insurance Carriers to use platform data, independent of a Carrier relationship with the platform owner, to make better decisions. The Platform's databases (including proprietary blockchains) contain data useful to the entire P&C insurance market. By providing data integrations for other Insurance Carriers and Agencies, the platform can provide and participate in the tracking of item history and provenance, item ownership, item insurance coverage, and digital identity to help detect fraud. As the other participants continue to write additional data back to the databases and/or blockchains, the platform continues to provide and benefit from additional knowledge being collected by the Property & Casualty insurance industry.

Thus, what is provided in various embodiments and implementations is a one-click insurance for brick and mortar and online retail (including online resellers), which may include blockchain tracking. In one implementation processor implementable application that plugs into a merchant's resident point of sale device, or into an online web-store to leverage customer and item data for easy insurance procurement. This embodiment may include, applying underwriting and rating rules to customer and item data for risk selection and insurance pricing. It further may include identifying and obtaining value the component parts of items for pinpoint accuracy of the subject of insurance and its related valuation (Diamond Ring=18 ct White Gold Setting+2.01 ct Round Diamond, L Color, VS2 Clarity, Very Good Cut+qty 2 of 1 ct Round Sapphire side stones). This implementation and other may interface with asset tracking blockchains and contribute to the record of ownership, including losses (based on purchases and losses/claims).

In further embodiments and implementations, real-time adjustment of insurance and premium based on inventory, values, and market data as shown in FIG. 4 at 401-415 is provided. In such an implementation, tracking of market data for value fluctuations of valuable assets (ex. gold, platinum, silver, diamonds and other gems) is employed so that market value adjustments to the items (the subject of insurance) is possible for pinpoint accuracy of value at any given point in time, for example intraday, daily, weekly, monthly, and/or yearly. This allows application of insurance rates to the fluctuating item value for real time premium development during an insurance policy's lifecycle. This may further include application of insurance rates to the movement of items as they move between different risk areas (i.e.—items moves from one city to another for 3 months in the summer). Some embodiments may interface with inventory management systems is provided to record a merchant's real time insurance exposure and cost through a perpetual inventory. Further, some embodiments may interface with blockchains to record a merchants or individuals real time insurance exposure and cost through a perpetual inventory. As such it is possible to apply insurance rates to the fluctuating inventory for real-time premium development during an insurance policy's lifecycle.

In some implementations, an online platform is provided for linking participants in the insuring, recording of assets, claims processing. Such implementations may include an easy to use online user interface or UI to enable policy owner to manage their items and manage their insurance coverage and claims for those items. In other or additional implementations, the online UI enables the wearer of the items/jewelry (if different than the owner) to manage their items and view information about their coverage (if enabled by the policy owner). In still further implementations, the online UI enables retailers to receive information about shared customer conversion. It may also be used to issue a replacement or repair request for a shared customer. It may further allow the retailer will update the system as they progress in making the repair or replacement and allow the customer to track progress until the repair/replacement is received. This history may then be integrated into the asset blockchain history as discussed above.

Various implementations may provide online UI for the insurance carrier to receive information on customers and claims and, if applicable, an online UI for any additional interest company to view and manage the items they hold an interest in (ie—financing of a diamond engagement ring) across multiple shared customers.

Some implementations may also provide an online UI for all police departments to interface with the platform for the purpose of the validation and management of the item loss. This can also include data integration to enable real-time sharing of information between the platform and various police reporting systems.

Implementations may include data integration with asset tracking blockchains for the purpose of obtaining and updating asset ownership and specifications for the purpose of underwriting new and managing existing insurance policies.

It is possible in some implementations to provide the digital identity embedded into the insurance purchase and process. This may include applying the digital identity of customers (KYC) that are established via industry developed blockchain and apply that digital identity to the application, management, and/or claims processing of insurance in order to reduce fraud and risk associated with insurance. This may further include recording the connection between the insurer, the insurance customer, the item owner, and the insurance policy.

It is further possible in some implementations, to provide a means for the insurance to go with an item as ownership changes. In such an implementation, insurance is placed on an item upon creation and recorded on a blockchain. The insurance then follows the item as it changes ownership (through supply chain, peer to peer, retail purchase, etc), and the record of ownership is updated on the blockchain. Insurance is then automatically updated to cover the item as it changes ownership by leveraging the data that resides on the blockchain for the purpose of the underwriting and policy management. Some implementations, may include applying underwriting validation and the ability to stop insurance coverage, or alter pricing, as ownership changes and risk profiles change and items are more, or less susceptible to loss.

Some implementations facilitate insurance for shared ownership of an asset (typically on blockchain). Digital insurance can be provided that records fractional ownership (i.e.—painting, time share real-estate) leveraging data that resides on the blockchain. Further, in some embodiments, insurance dynamically adjusts to apply to ownership changes and varying ownership percentages. This may further include recording of ownership, coverage amounts, and adjustment of ownership of asset on blockchain.

In some embodiments, it is possible to connect insurers to blockchains for data, which may be in the form of a subscription model. An online platform may be provided to enable insurance carriers to record and retrieve customers and item data from various blockchains for the purpose of providing their insurance services. Embodiments, may also provide integration to write back to the various blockchains as item ownership changes (i.e.—sales or losses).

In some embodiments, an insurance report (like a credit report) may be provided across all insurance on blockchain (cross industry initiative). Such an embodiment, records insurance of assets from various blockchains and collects insurance loss information, and records on blockchains (Items, customer, location, type of occurrence, settlement amount, subrogation, ownership updates if item now belongs to a particular insure). Further, from this information an insurance rating is provided that blockchain records, and which can be shared between the customer (their insurance rating) and the insurance industry for the purpose of underwriting criteria for insurance policies.

In one implementation, a method is provided for insuring an item at a point of purchase including providing a display comprising and activation field on the point of purchase device and providing item purchase information including customer specific information, item specific information, and purchase price information upon selection of the activation field, to a remote site rating engine, and further providing from the rating engine at least some the customer specific information to a third party risk evaluator and performing at the rating engine a customer risk valuation assessment based on customer specific risk information obtained from the third party risk evaluator. The method further includes performing at the rating engine an item valuation based on the purchase price and the item specific information including comparative sale data, item component valuation based on current market price, and any blockchain distributed ledger valuation history data related to the item. The method further includes performing at the rating engine an insurance premium calculation to generate an insurance quote based on the customer risk valuation assessment and the item valuation and providing to the point of purchase device the insurance quote for display on the point of purchase device and displaying at least one selection field on the point of purchase device to a customer corresponding to the customer specific data so as to allow binding of an insurance contract at the quoted premium from the point of purchase device concurrent with the sale of the item upon selection of the at least one selection field.

In some implementations included installing a plug-in processor implementable application into a merchant's point of sale device, the application providing the display including the activation field on the merchant's point of sale device. In some implementations, the activation field is a click box displayed on a merchant's point of sale device selectable by at least one of a touch screen or a mouse.

Some implementations may further include updating block chain cryptographic distributed ledger valuation history data related to the item upon the binding of the insurance contract.

In some applications, the processor implementable plugin/widget application may be installed on a personal handheld device, for use as a point of purchase or sale device at the retail partner 202 (FIG. 2), e.g. in the e-commerce checkout systems of online retailers to enable bidirectional real-time communication of data between the retailer (and/or customer) and a host platform 150. In some embodiments, such as in the e-commerce checkout systems, the point of sale device need not be at the retail partner's physical location. As such, in some embodiments, the plugin/widget application may be installed on a customer's personal handheld device, or personal desktop computer, remote from the merchant's physical location by an online merchant, which then may be used to either directly transmit the customer data, including some or all of the customer initial information, item specific information and purchase price information, or to initiate the transmission of such data from the web based server of a merchant to the host platform 150. In some embodiments, device separate from but optionally integrated with the point of sale system data may be used at the point of purchase which has a plug-in software application to enabling the retailer to present an insurance offer to the customer in real time via for example, a computer, or a tablet, separate from the point of sale device in the physical retail location.

In some embodiments, the owner of an item may take a picture of, enter, upload, etc., their item information (or even the item itself, 206i (FIG. 2)) into the platform (this would be a situation where the user is adding a different item that was not originally purchased via the retail partner in the example above). In this example the customer may store an inventory of their items (in this case their jewelry box so to speak) and have the ability to click to activate insurance for items that the owner selects. In the case where the item is found to be initially purchased via one of the retail partners, the platform would associate the item with the retail partner for when a claim might occur in the future. This scenario would also allow the platform to download information from the retail partner, blockchains, inventory management systems, jewelry grading labs, etc., in order to obtain additional information on the item being uploaded by the end consumer. A good example of this is using the GIA lab report number to contact the API of the GIA system to pull down detailed specifications on a previously graded diamond.

In some embodiments, the platform allows customers seeking value appraisals to upload new items to the platform via the web user interface 208 for value/appraisals. The platform could then direct the customer to go into one of the stores of our retailer so they can appropriately review and appraise so that the appraisal may be added to the customer data 204 by the retail partner.

In another implementations, a method for insuring an item at a point of purchase may include a plug-in software application, separate from but optionally integrated with the point of sale system data, enabling the retailer to present an insurance offer to a customer in real time via SMS or email.

What is claimed is:

1. A collaborative platform to inform and facilitate an intelligent purchase decision, the platform comprising:
a) a point of sale device comprising:
1) a processor; and
2) a processor implementable widget for receiving customer data comprising: (i) customer specific information; (ii) item specific information of an item; and (iii) purchase price information of the item, the widget being configured to transmit the customer data to a host server remote from the point of sale device;
b) the host server comprising a processor implementable rating engine, the rating engine being configured to:
1) provide the customer specific information to a third party evaluator;
2) perform a customer evaluation assessment based on third party customer information received from the third party evaluator;
3) perform an item valuation based on the purchase price information and the item specific information, wherein the item specific information includes:
(i) comparative sale data;
(ii) item component valuation data based on current market price of component portions of the item; and
(iii) valuation history data of the item;
4) determine whether the customer is eligible to purchase an additional purchase item based on the customer evaluation assessment and the item valuation; and
5) provide to the point of sale device one of either: (i) offer data related to the additional purchase item if the customer is eligible to purchase the additional purchase item, or (ii) rejection data if the customer is not eligible to purchase the additional purchase item; and
c) the point of sale device being configured to display the offer data and a selectable field on the point of sale device to a customer so as to allow the customer to complete the additional purchase.

2. The platform of claim 1, wherein the valuation history data of the item includes valuation history data from a blockchain distributed ledger.

3. The platform of claim 2, wherein the host server is further configured to determine a purchase price of the additional purchase item based on the customer evaluation assessment and the item specific valuation.

4. The platform of claim 3, wherein the host server is further configured update the blockchain distributed ledger after the additional purchase item is purchased.

5. The platform of claim 1, wherein the host is configured to perform an item valuation based on the purchase price information and the item specific information, wherein the item specific information includes the item component valuation data based on current market price of component portions of the item.

6. The platform of claim 1, wherein the host server is further configured to determine a purchase price of the additional purchase item based on the customer evaluation assessment and the item specific valuation.

7. The platform of claim 1, wherein the point of sale device comprises a merchant's point of sale device.

8. The platform of claim 1, wherein the point of sale device comprises a personal hand held device.

9. The platform of claim 1, wherein the point of sale device comprises a personal desktop computer.

10. The platform of claim 1, wherein the host server comprises one of: (a) a single processor based computer; or (b) a distributed computer system.

11. A method for insuring an item at a point of purchase comprising:
installing a plug-in processor implementable application into a merchant's point of sale device, the processor implementable application providing a display comprising and activation field on the merchant's point of sale device;
providing from the merchant's point of sale device item purchase information including customer specific information, item specific information, and purchase price information upon selection of the activation field, to a rating engine at a remote host site;
providing from the rating engine at least some of the customer specific information to a third party risk evaluator;
performing at the rating engine a customer risk valuation assessment based on customer specific risk information obtained from the third party risk evaluator;
performing at the rating engine an item valuation based on the purchase price and the item specific information, wherein the item specific information includes:
comparative sale data;
item component valuation data based on current market price; and
valuation history data related to the item from a third party blockchain distributed ledger;
performing at the rating engine an insurance premium calculation to generate an insurance quote based on the customer risk valuation assessment and the item valuation;
providing to the merchant's point of sale device the insurance quote for display on the point of sale device; and
displaying at least one selection field on the point of sale device to a customer corresponding to the customer specific data so as to allow binding of insurance at the quoted premium from the point of sale device upon selection of the at least one selection field.

12. The method of claim 11 further comprising updating blockchain cryptographic distributed ledger valuation history data related to the item upon the binding of the insurance.

13. The method of claim 11, wherein the activation field is a click box displayed on the point of sale device selectable by at least one of a touch screen or a mouse.

14. A method for insuring an item at a point of purchase comprising:
installing a plug-in application on a retailer's e-commerce checkout system, the plug-in application providing a display comprising and activation field on the user's point of purchase device;
providing item purchase information including customer specific information, item specific information, and purchase price information upon selection of the activation field, to a remote site rating engine;
providing from the rating engine at least some the customer specific information to a third party risk evaluator;
performing at the rating engine a customer risk valuation assessment based on customer specific risk information obtained from the third party risk evaluator;
performing at the rating engine an item valuation based on the purchase price and the item specific information, wherein the item specific information includes:
comparative sale data; and
item component valuation data based on current market price;
performing at the rating engine an insurance premium calculation to generate an insurance quote based on the customer risk valuation assessment and the item valuation;
providing to the user's point of purchase device the insurance quote for display on the user's point of purchase device; and
displaying at least one selection field on the point of purchase device to a customer corresponding to the customer specific data so as to allow binding of an insurance contract at the quoted premium from the point of purchase device upon selection of the at least one selection field.

15. The method of claim 14 further comprising updating blockchain cryptographic distributed ledger valuation history data related to the item upon the binding of the insurance contract.

16. The method of claim 14, wherein performing the item valuation based on the purchase price and the item specific information at the rating engine comprises using a blockchain distributed ledger valuation history data related to the item.

17. The method of claim 16 further comprising updating blockchain cryptographic distributed ledger valuation history data related to the item upon the binding of the insurance.
